(19) United States
(12) Patent Application Publication
(10) Pub. No.: US 2018/0072217 A1
(43) Pub. Date: Mar. 15, 2018

(54) HAZARD LIGHT SWITCH ASSEMBLIES FOR AN AUTOMOBILE

(71) Applicant: Ford Global Technologies LLC, Dearborn, MI (US)

(72) Inventor: Salman Nazir Shami, Doreen (AU)

(21) Appl. No.: 15/680,106

(22) Filed: Aug. 17, 2017

(30) Foreign Application Priority Data
Sep. 14, 2016 (CN) 201610825855.7

(51) Int. Cl. B60Q 1/00; B60K 37/06; H01H 13/14; H01H 13/02

(52) U.S. Cl. CPC B60Q 1/0076; B60K 37/06; H01H 13/14; H01H 2231/026; B60K 2350/106; B60K 2350/1028; B60K 2350/1076; H01H 13/023

(57) ABSTRACT

A hazard light switch assembly of an automobile comprises a human-machine interface (HMI) device having a touchscreen and a frame, a hinge connecting the frame of the HMI device to an interior surface of the automobile, and a hazard light switch mounted to an instrument panel of the automobile behind the HMI device. The frame of the HMI device may include a hazard light symbol. The hazard light switch and the frame of the HMI device may be configured such that applying a force on or near the hazard light symbol triggers the hazard-light switch.

### RELATED APPLICATION

This application claims the benefit of Chinese Patent Application No.: CN 201610825855.7 filed on Sep. 14, 2016, the entire contents thereof being incorporated herein by reference.

### FIELD

The present disclosure relates generally to hazard light switches in automobiles. In particular, hazard light switch assemblies which integrate the actuation of the hazard light switch with an in-dash touchscreen are described.

### BACKGROUND

Known hazard light switches for automobiles are not entirely satisfactory for the range of applications in which they are employed. Specifically, existing hazard light switch designs are not integrated with modern in-dash touchscreen systems. Mechanically actuated hazard light switches, which work even if the in-dash touchscreen is powered down or when a power source for the automobile is off, are commonly provided in a vehicle in order to conform to automobile safety regulations. Thus, conventional automobile interior designs that have employed in-dash touchscreens have included a separate hazard light switch, usually located on the dashboard somewhere near the touchscreen.

The inventor has recognized that an individual hazard light switch separately disposed from the touch screen may impose limits on the overall design of dash board and affect the aesthetic appearance of dash board. Thus, there exists a need for hazard light switch designs that improve upon and advance the design of known such switches. Examples of new and useful hazard light switches relevant to the needs existing in the field are discussed below.

### SUMMARY

According to one aspect, a hazard light switch assembly of an automobile may include a human-machine interface (HMI) device having a touchscreen and a frame, a hinge connecting the frame of the HMI device to an interior surface of the automobile, and a hazard light switch mounted to an instrument panel of the automobile behind the HMI device. The frame of the HMI device may include a hazard light symbol. The hazard light switch and the frame of the HMI device may be configured such that applying a force on or near the hazard light symbol triggers the hazard-light switch.

In one embodiment, the HMI device may control at least one of: air-conditioning, heat, entertainment, car information and navigation features of the automobile.

In another embodiment, the hazard-light switch may comprise a status indication light.

In another embodiment, the hazard light symbol of the frame may be at least partially translucent.

In another embodiment, the status indication light may be configured to transmit visible light through the hazard light symbol.

In another embodiment, the hinge of the hazard light switch assembly may comprise a living hinge.

In another embodiment, the hinge may comprise a pin mounted in a cylindrical housing.

In another embodiment, the cylindrical housing may be secured to a lower member of the frame.

In another embodiment, the cylindrical housing may be secured to a side portion of the frame.

In another embodiment, the hazard light switch assembly may comprise a spring mounted behind the frame. Applying the force on the frame causes the frame to rotate via the hinge and the spring is configured to return the frame to the normal position after applying the force.

In another embodiment, the hazard light switch may comprise a momentary single position single throw (SPST) push button.

In another embodiment, the spring may be coiled around the momentary SPST push button.

According to another aspect, an instrument panel of an automobile may comprise an HMI device including a touchscreen and a rigid frame, a connection member rotatably connecting the frame to an automobile part and disposing the HMI device on the instrument panel, a hazard-light switch mounted to an instrument panel of the automobile and behind the touchscreen, and a spring mounted behind the frame. Applying a force on or near the hazard-light symbol may cause the frame to rotate via the connecting member and triggers the hazard light switch. The spring may be configured to return the frame to a normal position after applying the force.

In one embodiment, the automobile part attached to the connection member may be a central console or a main structure of the instrument panel.

In another embodiment, the connection member may comprise a living hinge.

In another embodiment, the connection member may comprise a pin mounted in a cylindrical housing.

In another embodiment, the connection member may be secured to a lower member of the frame, the hazard light switch may be disposed adjacent to an upper member of the frame, and the upper member may be spaced apart from surrounding components.

The hazard light assembly of the present disclosure integrates the hazard light switch with an HMI device physically by disposing the hazard light switch under the frame of the MHI screen. In this way, it is possible to have the HMI device as a more comprehensive user interface and eliminate the need for a separately disposed hazard light switch. Such configuration provides an instrument panel with better aesthetic appearance and creates a brand identification for the automobile.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a perspective view of a first example embodiment of a hazard light switch assembly of an automobile, including a HMI device with a frame supported via a connecting member.

FIG. 2 is a detailed perspective view of the connecting member of the hazard light switch assembly of FIG. 1.

FIG. 3 is a side elevation view of one embodiment of the connecting member of FIG. 2.

FIG. 4 is a cross-sectional view of an upper portion of the hazard light switch assembly of FIG. 1, showing the hazard light switch in relation to the frame and a portion of the dashboard of the automobile.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed hazard light switch assemblies will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various hazard light switch assemblies are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

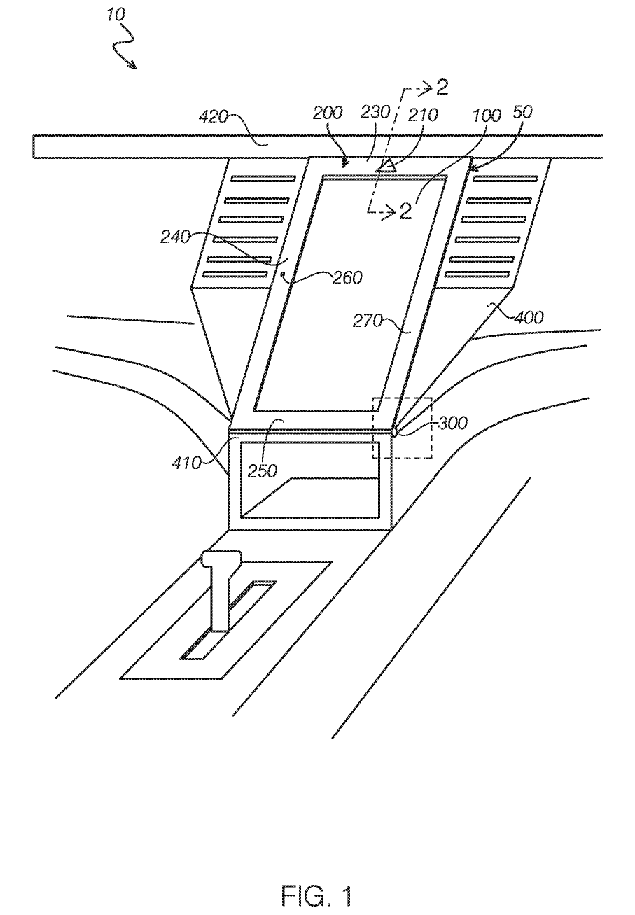

With reference to FIGS. 1-4, a first example embodiment of a hazard light switch assembly, assembly 10, will now be described. Assembly 10 functions to support a touchscreen while also providing a streamlined mechanical hazard light switch. Thus, assembly 10 eliminates the need for a hazard light switch in a separate location on the instrument panel. The reader will appreciate from the figures and description below that assembly 10 addresses shortcomings of the prior art.

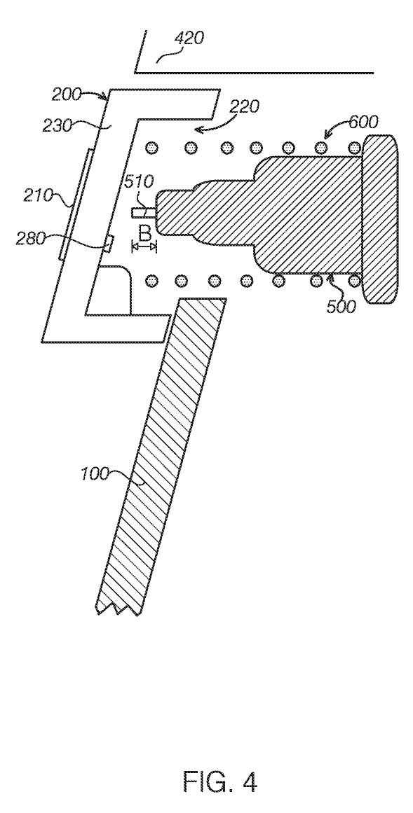

Referring to FIGS. 1 and 4, assembly 10 includes a human-machine interface (HMI) device 50 comprised of a touchscreen 100 and a rigid frame 200, a connecting member 300 supporting the frame, and a hazard light switch 500 mounted behind the HMI device 50. In the illustrated embodiment, the connecting member 300 is a hinge that secures the frame 200 while allowing the frame to rotate under a force. Pressing on one side of the frame 200 may cause the frame 200 to rotate via the hinge 300, thereby triggering the hazard light switch 500 behind the frame so as to turn on or turn off.

As can be seen in FIG. 1, frame 200 may include a hazard light symbol 210 to indicate a hazard light switch. Pressing on the hazard light symbol 210 may activate hazard light switch 500 to generate hazard lights. In the illustrated embodiment, hazard light switch 500 is disposed behind an upper portion 230 of frame 200, and the hazard light symbol 210 is located on the upper portion 230 of frame 200. In other embodiments, the hazard light symbol 210 may be located on a side portion 240 of the frame. In still other embodiments, the hazard light symbol 210 may be located on a bottom portion 250 of the frame 200. It should be appreciated that the hazard light symbol 210 may be located on any appropriate portion of the frame 200 depending on the location of the connecting member, the hazard light and/or the location of the HMI device on the instrument panel.

The HMI device 50 may control one or more functions of an automobile. For example, touchscreen 100 may control at least one of: heating, ventilating and air conditioning (HVAC), phone communication, entertainment, car information and navigation. The control may be executed via a user interface or the touch screen 100 of the HMI device 50. In some embodiments, the HMI 50 may control substantially all automobile functions except the hazard light switch 500. The hazard light switch is required by the regulation to be functioning independently, that is, the hazard light switch 500 should be connected to an independent circuit and an independent power source so that the hazard lights can turn on or off even at the condition where a main power system of the automobile is powered down. However, the hazard light switch 500 may be concealed from view of the occupants of the automobile.

As shown in FIG. 1, hinge 300 attaches the bottom portion 250 of frame 200 to a lower portion 410 of the instrument panel 400. The upper portion of frame 200 is not fixed. Hinge 300 is configured to hold frame 200 at a specific position but frame 200 may rotate about hinge 300 under a force and return to a normal position or the specific position after the force is released. As detailed below, rotation of frame 200 may activate or deactivate the hazard light switch. It should be appreciated that hinge 300 may be attached to any appropriate place such as attached to a central console of the vehicle depending on the design of the automobile.

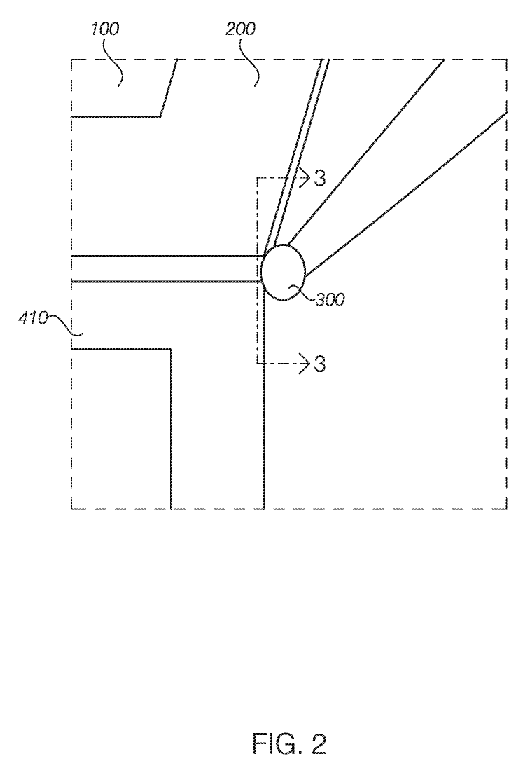

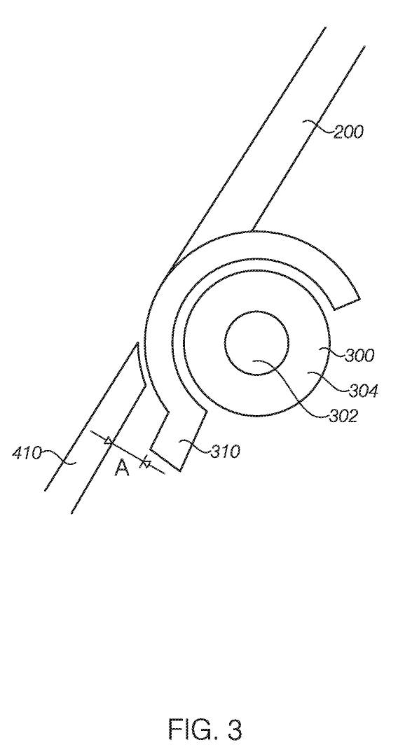

Turning now to FIG. 2, a detailed view of connecting member 300 is shown. In some embodiments, connecting member 300 may have a hinge structure. In one embodiment, the connecting member may comprise a living hinge (not shown). In this regard hinge 300 may comprise a flexible material, such as a flexible plastic. Further referring to FIG. 3, in other embodiments, hinge 300 may comprise a pin 302 mounted in a cylindrical housing 304. The connecting member 300 may have any appropriate structure that enables the frame 300 to be fixed at a specific position and rotated at a specific range under a force.

As shown, hinge 300 may be secured to a lower member of frame 200. In other embodiments, the hinge may be secured to the frame in alternative locations depending on the location of the hazard light switch. For example, in one embodiment, the hinge may be attached to a side portion 240 of the frame around a mid-point 260 while the hazard light switch is disposed under upper portion 230 or under a side portion 270 opposite to side portion 240 of the frame. In another embodiment, the hinge may be attached to an upper member of the frame while hazard light switch is disposed under a bottom portion 250 of the frame. The hazard light switch may be located on a position opposite the hinge so that a torque may be created to move the frame when a force is applied on or around the hazard light symbol.

Turning now to FIG. 3, an enlarged cross-sectional view from the section 3-3 in FIG. 2 is shown. In the illustrated embodiment, the lower portion of frame 200 includes a stop member 310. As the frame 200 is rotated to the right or the frame 200 is pressed down, stop member 310 engages with interior panel 410, thereby preventing further rotation. Thus, frame 200 may be allowed to rotate a distance A from a normal position to a fully rotated position.

Turning now to FIG. 4, a cross sectional view of the hazard light switch assembly at section 2-2 is illustrated. In the illustrated embodiment, hazard light switch 500 is mounted behind the upper portion 230 of frame 200. The hazard light switch 500 may be mounted to the instrument panel 400 of the automobile. In some embodiments, hazard light switch 500 and spring 600 may be at least partially housed within a recess 220 of frame 200. In the illustrated embodiment, the upper portion 230 of frame 200 is spaced apart from the surrounding components 420 (e.g., the dashboard, central console, and/or instrument panel) to allow frame 200 to be pushed down against the hazard light switch or rotate around hinge 300.

In the illustrated embodiment, hazard light symbol 210 is disposed on frame 200 in front of switch 500. Hazard light symbol 210 may be located on an opposite side of frame 200 from hinge 300. Thus, a user may apply a force to (e.g., push the frame) the hazard light symbol 210 in order to rotate frame 200.

Hazard light switch 500 may be a conventional hazard light switch having a momentary single position single throw (SPST) push button. Each time the button is pressed, the state of the circuit changes. The momentary SPST push button does not stay in the down position and always returns to the normal position. That is, when the user applies a force by pressing the frame 200 down, the hazard light will be turned on but the frame 200 returns to the normal position once the force is released. The hazard light will be turned off when the user presses the frame again. In the illustrated embodiment, hazard light switch 500 has a depressible push button tip 510. The push button tip 510 may be depressed a distance B. In some embodiments, the distance B may be matched to the distance of rotation A of the frame 200 or the distance of rotation A of the frame 200 may be configured according to the distance B.

In some embodiments, hazard light switch assembly 100 may include a status indication lamp 280 that is electrically connected to a circuit of the hazard light. Lamp 280 is turned on when the hazard lights are activated and turned off when the hazard lights are deactivated. The material consisting of the hazard light symbol 210 may be at least partially translucent or may have red color. Thus, the status indication light from lamp 280 may transmit visible light through the hazard light symbol. In some embodiments, the entire frame may be configured to be flash red when the hazard lights are activated so that the effect showing the activated hazard lights is more significant.

In some embodiments, a spring 600 may be disposed behind the frame 200. The spring 600 may function to assist the frame to return to a normal (e.g., neutral) position to account for the weight of the frame after the frame has been pushed down. In the illustrated embodiment, spring 600 is coiled around switch 500. In other embodiments, the spring may be located in alternative positions behind the frame.

The hazard light assembly of the present disclosure integrates the hazard light switch with an HMI device physically by disposing the hazard light switch under the frame of the MHI screen and an individually hazard light switch is not visible. In this way, it is possible to have the HMI device as an only user interface and eliminate other buttons in the automobile. Such configuration not only provides an instrument panel with better aesthetic appearance but also creates a brand identification for the automobile.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A hazard light switch assembly of an automobile, comprising:
a human-machine interface (HMI) device including a touchscreen and a rigid frame, wherein the frame includes a hazard light symbol;
a hinge connecting the frame to an interior surface of the automobile; and
a hazard light switch mounted to an instrument panel of the automobile and behind the HMI device such that applying a force on or near the hazard light symbol triggers the hazard light switch.

2. The hazard light switch assembly of claim 1, wherein the HMI device controls at least one of: heating, ventilating and air conditioning (HVAC), phone communication, entertainment, car information and navigation.

3. The hazard light switch assembly of claim 1, further comprising a status indication lamp to generate a status indication light when hazard lights are activated.

4. The hazard light switch assembly of claim 3, wherein the hazard light symbol is at least partially translucent.

5. The hazard light switch assembly of claim 4, wherein the status indication lamp is configured to transmit visible light through the hazard light symbol.

6. The hazard light switch assembly of claim 1, wherein the hinge comprises a living hinge.

7. The hazard light switch assembly of claim 1, wherein the hinge comprises a pin mounted in a cylindrical housing.

8. The hazard light switch assembly of claim 7, wherein the cylindrical housing is secured to a lower member of the frame.

9. The hazard light switch assembly of claim 7, wherein the cylindrical housing is secured to a side portion the frame.

10. The hazard light switch assembly of claim 1, further comprising a spring mounted behind the frame, wherein applying the force causes the frame to rotate via the hinge and the spring is configured to return the frame to the normal position after applying the force.

11. The hazard light switch assembly of claim 10, wherein the hazard light switch comprises a momentary single position single throw (SPST) push button.

12. The hazard light switch assembly of claim 11, wherein the spring is coiled around the momentary SPST push button.

13. An instrument panel of an automobile, comprising:
an HMI device including a touchscreen and a rigid frame, wherein the frame includes a hazard light symbol;
a connection member rotatably connecting the frame to an automobile part and securing the HMI device on the instrument panel;
a hazard-light switch mounted to the instrument panel of the automobile and behind the touchscreen such that applying a force on or near the hazard-light symbol causes the frame to rotate via the connecting member and triggers the hazard light switch; and
a spring mounted behind the frame, wherein the spring is configured to return the frame to a normal position after applying the force.

14. The instrument panel of claim 13, further comprising a status indication lamp to generate a status indication light, and the hazard light symbol is at least partially translucent.

15. The instrument panel of claim 14 wherein the status indication lamp is configured to transmit visible light through the hazard light symbol.

16. The instrument panel of claim 13, wherein the automobile part is a central console or a main structure of the instrument panel.

17. The instrument panel of claim 13, wherein the connection member comprises a living hinge.

18. The instrument panel of claim 13, wherein the connection member comprises a pin mounted in a cylindrical housing.

19. The instrument panel of claim 13, wherein the connection member is secured to a lower member of the frame.

20. The instrument panel of claim 13, wherein the connection member is secured to a lower member of the frame, the hazard light switch is disposed adjacent to an upper member of the frame, and wherein the upper member is spaced apart from surrounding components.
